(19) United States
(12) Patent Application Publication
(10) Pub. No.: US 2025/0225685 A1
(43) Pub. Date: Jul. 10, 2025

(54) METHOD AND APPARATUS WITH CONDITIONAL SAMPLING

(71) Applicant: Samsung Electronics Co., Ltd., Suwon-si (KR)

(72) Inventors: Jin Young SHIN, Suwon-si (KR); Hyun Sung CHANG, Suwon-si (KR); Heewon KIM, Suwon-si (KR)

(73) Assignee: Samsung Electronics Co., Ltd., Suwon-si (KR)

(21) Appl. No.: 18/826,690

(22) Filed: Sep. 6, 2024

(30) Foreign Application Priority Data
Jan. 8, 2024 (KR) 10-2024-0003033

(51) Int. Cl. G06T 11/00

(52) U.S. Cl. CPC G06T 11/00

(57) ABSTRACT

A processor-implemented method includes obtaining input data that corresponds to noise, iteratively updating the input data based on a diffusion model and a condition model, and outputting image data that meets a sampling condition based on the iteratively updated data.

### CROSS-REFERENCE TO RELATED APPLICATIONS

This application claims the benefit under 35 USC § 119 (a) of Korean Patent Application No. 10-2024-0003033, filed on Jan. 8, 2024 in the Korean Intellectual Property Office, the entire disclosure of which is incorporated herein by reference for all purposes.

### BACKGROUND

### 1. Field

The following description relates to a method and apparatus with conditional sampling.

### 2. Description of Related Art

A diffusion model may be used as a data generation model. The diffusion model may express data x₀ through a diffusion process that gradually changes according to x₀→x₁→ . . . →x_{T}, with the data x₀ as a starting point and a pure noise sample x_{T} as an ending point.

Sampling may follow an opposite path of the diffusion process. For example, sampling may estimate \hat{x}_{T-1|T}= [symbol] [x_{T-1}|x_{T}] starting from the pure noise sample x_{T}, and may add noise that indicates uncertainty to obtain a sample for x_{T-1}. Here, a key role of estimating \hat{x}_{T-1|T} may be played by a neural network, which may be trained to perform that role during a training process.

In a narrow sense, the diffusion model may also refer to the neural network. When the above process is iterated for all steps t in a reverse order of timepoints from T to 1, a data sample x₀ may finally be obtained, which may ultimately be identical to sampling based on marginal distribution p_{π}(x₀) implied by the diffusion model.

In conditional sampling, a neural network may be used to configure a likelihood model to generate an image that meets a specific class condition or a specific text-based description condition.

For example, a likelihood model for a specific class condition may be configured through the softmax output of a classifier, and a likelihood model for a text-based description condition may be defined through the correlation between an output of an image encoder and an output of a text encoder for a textual description.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes obtaining input data that corresponds to noise, iteratively updating the input data based on a diffusion model and a condition model, and outputting image data that meets a sampling condition based on the iteratively updated data.

The iterative updating of the input data may include obtaining first data corresponding to the diffusion model and second data corresponding to the condition model, wherein the first data and the second data are output in a previous iteration, and updating the obtained first data and the obtained second data in parallel based on the diffusion model and the condition model.

The method may include updating a linear coefficient to indicate a relationship between the first data and the second data, wherein the updated linear coefficient is used in determining the first data and the second data in a next iteration.

The obtaining of the first data corresponding to the diffusion model and the second data corresponding to the condition model may include determining the second data based on the first data.

The iterative updating of the input data may include iteratively updating the input data based on an alternating direction method of multipliers (ADMM) that processes the diffusion model and the condition model in parallel.

The condition model may include a function for a task of the output image data.

The iterative updating of the input data may include reducing a step of updating the input data to 0 in a level unit of “1” or higher.

The method may include performing a second update, which iteratively updates the image data based on the diffusion model, and outputting translated data that meets a translation condition by iterating a first update based on a result of the second update, the first update being the iterative updating of the input data.

In one or more general aspects, a processor-implemented method includes obtaining image data, performing a first update, which iteratively updates the image data based on a diffusion model and a condition model, performing a second update, which iteratively updates the image data based on the diffusion model, and outputting translated data that meets a translation condition by iterating the first update based on a result of the second update.

The condition model may include a function that indicates a translation condition according to a semantic feature of the image data.

The performing of the first update may include obtaining first data corresponding to the diffusion model and second data corresponding to the condition model comprising a result of the second update, wherein the first data and the second data are output in a previous iteration, and updating the obtained first data and the obtained second data in parallel.

The obtaining of the first data corresponding to the diffusion model and the second data corresponding to the condition model comprising the result of the second update may include determining the second data based on the first data.

The performing of the first update may include iteratively updating the image data based on an alternating direction method of multipliers (ADMM) that processes the diffusion model and the condition model in parallel.

In one or more general aspects, a non-transitory computer-readable storage medium may store instructions that, when executed by one or more processors, configure the one or more processors to perform any one, any combination, or all of operations and/or methods disclosed herein.

In one or more general aspects, an apparatus includes one or more processors configured to obtain input data that corresponds to noise, iteratively update the input data based on a diffusion model and a condition model, and output image data that meets a sampling condition based on the iteratively updated data.

For the iterative updating of the input data, the one or more processors may be configured to obtain first data corresponding to the diffusion model and second data corresponding to the condition model, wherein the first data and the second data are output in a previous iteration, and update the obtained first data and the obtained second data in parallel based on the diffusion model and the condition model.

The one or more processors may be configured to update a linear coefficient to indicate a relationship between the first data and the second data, wherein the updated linear coefficient is used in determining the first data and the second data in a next iteration.

For the obtaining of the first data corresponding to the diffusion model and the second data corresponding to the condition model, the one or more processors may be configured to determine the second data based on the first data.

For the iterative updating of the input data, the one or more processors may be configured to iteratively update the input data based on an alternating direction method of multipliers (ADMM) that processes the diffusion model and the condition model in parallel.

In one or more general aspects, an apparatus includes one or more processors configured to obtain image data, perform a first update, which iteratively updates the image data based on a diffusion model and a condition model, perform a second update, which iteratively updates the image data based on the diffusion model, and output translated data that meets a translation condition by iterating the first update based on a result of the second update.

Other features and aspects will be apparent from the following detailed description, the drawings, and the claims.

### BRIEF DESCRIPTION OF THE DRAWINGS

FIG. 1 illustrates a flowchart of an example of a method of performing conditional sampling by an apparatus.

FIG. 2 illustrates an example of a configuration for conditional sampling.

FIG. 3 illustrates an example of an operating method for obtaining image data that satisfies a sampling condition through an alternating direction method of multipliers (ADMM).

FIG. 4 illustrates a flowchart of an example of an operating method of an apparatus for image-to-image translation.

FIG. 5 illustrates an example of a configuration for image-to-image translation.

FIGS. 6A and 6B illustrate examples of image-to-image translation.

FIG. 7 illustrates a block diagram of an example of an apparatus.

FIG. 8 illustrates an example of applying conditional sampling to an image signal process (ISP) module.

FIG. 9 illustrates an example of an operation for data augmentation.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms including technical or scientific terms used herein have the same meaning as those commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the present disclosure and are not to be interpreted in an idealized or overly formal sense unless expressly so defined herein.

When describing the examples with reference to the accompanying drawings, like reference numerals refer to like components and a repeated description related thereto is omitted. In the description of examples, detailed description of well-known related structures or functions is omitted when it is deemed that such description may cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The same name may be used to describe components having a common function in different examples. Unless otherwise mentioned, the description of one example may be applicable to other examples. Thus, duplicated description is omitted for conciseness.

In a Bayesian inference process, conditional sampling may be induced by using a diffusion model as a prior data probability (or likelihood) model.

In a process of inducing conditional sampling, conditional distribution p(y|xₜ₋₁) may be determined for each sampling step t. This means that when using a neural network as a likelihood model, the neural network may use data, on which a series of neural networks are trained, for data including noise of various noise levels. A likelihood model used as a condition for sampling may be expressed as p(y|x₀), e.g., a model that may be used when a pure image x₀ is given. However, determination of p(y|xₜ₋₁) may be difficult, and a neural network may be needed to respond to all noise levels, e.g., t, when p(y|x₀) is given as a neural network and accordingly, the efficiency of a typical model may decrease.

In the case of a likelihood model based on a physical and mathematical model, approximation or a heuristic method are typically used since it may be difficult to expand or induce for data including noise.

In addition, in a conditional sampling process, a diffusion model may be trained so that a condition model y corresponding to a condition may be received as an input to the diffusion model, which is training on joint data including x₀ and y. Since an amount of training data may be far greater and the trained neural network may be dependent on the condition model y, an efficiency of the neural network used in the typical conditional sampling process may decrease.

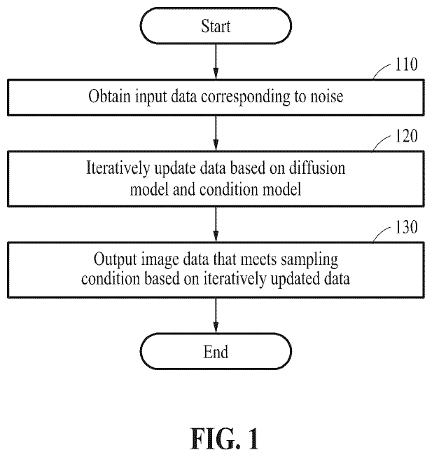

FIG. 1 illustrates a flowchart of an example of a method of performing conditional sampling by an apparatus.

Operations 110 to 130 to be described hereinafter may be performed sequentially in the order and manner as shown and described below with reference to FIG. 1, but the order of one or more of the operations may be changed, one or more of the operations may be omitted, and two or more of the operations may be performed in parallel or simultaneously without departing from the spirit and scope of the example embodiments described herein.

The apparatus may perform conditional sampling through operations 110 to 130. Conditional sampling may be a method of sampling data that meets an inference condition based on a diffusion model.

In operation 110, the apparatus may obtain input data that corresponds to noise.

In operation 110, the apparatus may receive, as the input data, the input data that corresponds to pure noise.

In operation 120, the apparatus may iteratively update the data based on a diffusion model and a condition model.

In operation 120, conditional sampling may be performed by updating outputs of the diffusion model and the condition model by a predetermined number of iterations through a module that processes the diffusion model and the condition model in parallel.

Here, the condition model may include a condition function corresponding to an estimation condition and may include a network. The condition may include information on a condition of a final output image. For example, the condition may include deblurring, which obtains a clear image from a shaky image, inpainting, which erases an object and restores a portion of an image when the portion is obscured by the object, text-based image production, change of an image style, and color demosaicking.

For the input data, first data may be output from the diffusion model and second data may be obtained from the condition model. Here, the second data obtained from the condition model may be determined based on the first data obtained through the diffusion model. For example, the second data may be updated so that the data sampled from the first data may satisfy the condition model.

To this end, data may be iteratively updated based on an alternating direction method of multipliers (ADMM). The ADMM may be a model for finding a balance between the diffusion model and the condition model, and each proximal operator may be iteratively used between likelihood models to satisfy a prior condition of projection onto a data space (i.e., manifold) through a reverse process of the diffusion process of the diffusion model.

Thereafter, the first data and the second data may be updated in parallel through the ADMM of the diffusion model and the condition model.

During an update process described above, a linear coefficient may be generated to indicate a relationship between the first data and the second data, and the linear coefficient may also be continuously updated during the update process.

The updated linear coefficient may be used to determine the first data and the second data in a next iteration.

In operation 130, the apparatus may output image data that meets the sampling condition based on the iteratively updated data.

The first data may be obtained at a timepoint at which a predetermined number of sampling iterations end. The image data may be obtained as image data for which condition-based sampling has been completed.

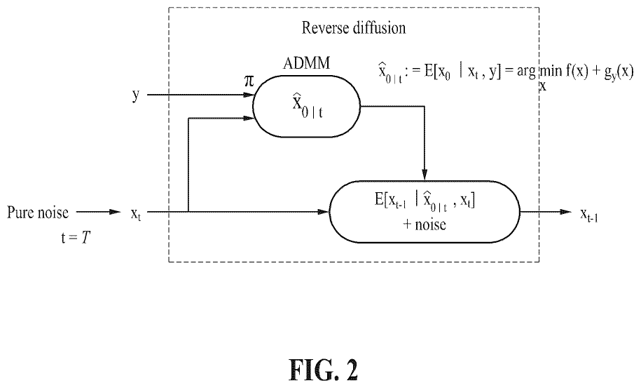

FIG. 2 illustrates an example of a configuration for conditional sampling.

When the condition model y is given together, a conditional estimate for data x₀ may be determined through the ADMM.

First, when sampling denoising using a diffusion model, x₍ₜ₋₁₎ that satisfies the condition model y may be obtained using the ADMM. The ADMM may operate to ensure consistency between data generated in a reverse process of a diffusion process and a given condition.

Through the ADMM, a sampling path of xₜ may be induced to a path that samples to satisfy the condition model y. For g_{y}(x), a measurement function that meets the condition model y may be used.

When the condition model y is given, an estimation process, which proceeds in an opposite path of the diffusion process, may obtain \hat{x}_{t-1@t}= [symbol] [xₜ₋₁|xₜ, y] and may be expanded using an iterated expectation formula as follows in Equation 1 below, for example.

$$\begin{matrix}{x}_{t - 1 \vert t} = 𝔼 [ {x}_{t - 1} \vert {x}_{t} , y ] = 𝔼 [ 𝔼 [ {x}_{t - 1} \vert {x}_{0} , {x}_{t} , y ] ] \\ = 𝔼 [ {a}_{t} {x}_{0} + {b}_{t} {x}_{t} \vert {x}_{t} , y ] = {a}_{t} 𝔼 [ {x}_{0} \vert {x}_{t} , y ] + {b}_{t} {x}_{t}\end{matrix} \qquad Equation 1$$

In Equation 1, aₜ and bₜ denote constants that depend on a parameter of the diffusion process, and semantically indicate linear coefficients in an environment in which two variables x₀ and xₜ are given, wherein an expected value of x₍ₜ₋₁₎ is expressed using the two variables x₀ and xₜ.

According to Equation 1, the only item that is to be determined at each step t for conditional sampling may be E[x₀|xₜ,y]. The E[x₀|xₜ,y] may be approximately determined using the ADMM.

Finally, an estimate for x₀ may be determined from xₜ and y through an operation of the ADMM.

Since an updating process through the ADMM may be implemented through a numerical algorithm of back-propagation, training on data including noise may not be needed when training a neural network that constitutes a likelihood model.

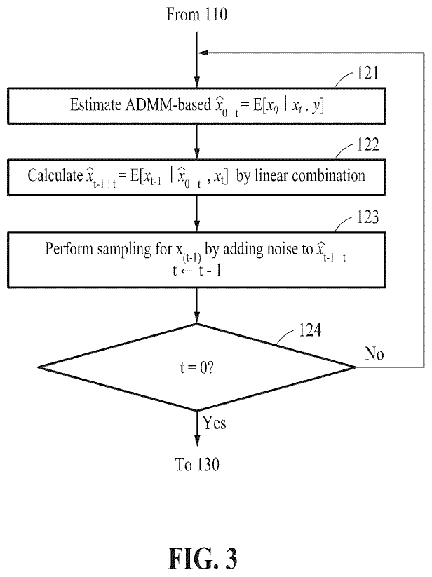

FIG. 3 illustrates an operating method for obtaining image data that satisfies a sampling condition through the ADMM. Operations 121 to 124 described below may be performed in the order and manner as shown and described below with reference to FIG. 3, but the order of one or more of the operations may be changed, one or more of the operations may be omitted, and/or two or more of the operations may be performed in parallel or simultaneously without departing from the spirit and scope of the example embodiments described herein.

Image data may be obtained using noise obtained through operation 110 described with reference to FIG. 1.

In operation 121, the apparatus may estimate an ADMM-based \hat{x}_{0|t}= [symbol] [x₀|xₜ, y].

In operation 122, the apparatus may determine \hat{x}_{t-1|t} by linear combination. This determination formula may be expressed to include linear coefficients of aₜ and bₜ derived by a parameter of a diffusion process.

In operation 123, the apparatus may perform sampling for x₍ₜ₋₁₎ by adding noise to \hat{x}_{t-1|t}.

A process of determining \hat{x}_{0|t}= [symbol] [x₀|xₜ, y] may be configured to iterate an interaction of an operation of applying a prior proximal operator and an operation of applying a prior proximal operator of a likelihood model. The operation of applying a prior proximal operator may be included in a neural network for implementing a diffusion model.

Referring to FIG. 3, sampling may be iterated with steps from t=T to t=0, and a step of updating data may be reduced to 0 in a level unit of “1” or higher. For example, Δt may be a value greater than or equal to “1.”

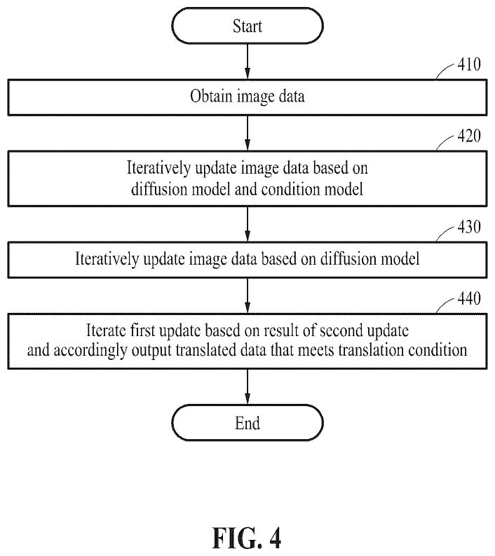

FIG. 4 illustrates a flowchart of an example of an operating method of an apparatus for image-to-image translation. Operations 410 to 440 described below may be performed in the order and manner as shown and described below with reference to FIG. 4, but the order of one or more of the operations may be changed, one or more of the operations may be omitted, and/or two or more of the operations may be performed in parallel or simultaneously without departing from the spirit and scope of the example embodiments described herein.

The operation described below may be for obtaining a sample in which semantic translation has been applied to image data through the apparatus.

In operation 410, the apparatus may obtain image data.

In operation 420, the apparatus may iteratively update the image data based on a diffusion model and a condition model.

In addition, in operation 430, the apparatus may iteratively update the image data based on the diffusion model.

In operations 420 and 430, parallel sampling may be performed on the image data using two diffusion models.

For the image data, first data may be output from the diffusion model and second data may be obtained from the condition model. Here, the second data obtained from the condition model may be determined based on the first data obtained through the diffusion model. For example, the second data may be updated so that the data sampled from the first data may satisfy the condition model.

In addition, sampling may be performed on the image data using the diffusion model so that the updated data may refer to the image data which corresponds to original data.

Data sampled by the diffusion model may be used by a condition function to determine an input-output relationship so that unnecessary translation may not be performed from the image data.

In operation 440, the apparatus may iterate the update performed in operation 420 based on an update result of operation 430 and may accordingly output translated data that meets a translation condition.

The output translated data may correspond to image data that meets the translation condition of translating data to be closer to the original data compared to the image data.

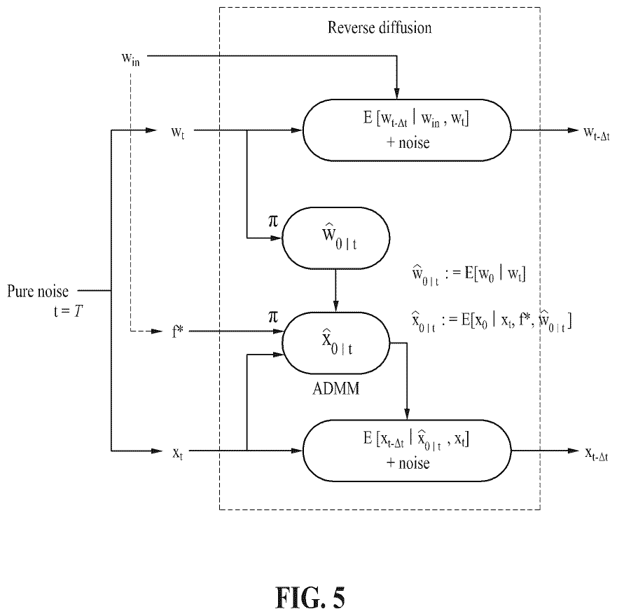

FIG. 5 illustrates an example of a configuration for image-to-image translation.

An apparatus may process image-to-image translation through parallel sampling of a diffusion model, as shown in FIG. 5.

When obtaining a sample in which semantic translation is applied to an input image Win is intended, a condition y may be obtained by extracting a semantic feature for the input image Win and applying a desired semantic translation to the semantic feature.

Subsequently, sampling may be performed while satisfying the condition y. Since a semantic feature may usually be expressed by compressing a semantic portion of an original image, an image sampled in this way may be significantly different from the input image Win in aspects other than the semantic translation.

Hereinafter, a method of following the input image Win as much as possible other than the semantic translation, as shown in FIG. 5, is described. To implement this, two sampling processes may be performed using a diffusion model. The first sampling process may perform sampling with reference to the input image Win, and the second sampling process may perform conditional sampling with the condition y applied. For example, the second sampling process may be the conditional sampling described with reference to FIGS. 1 to 3.

Image-to-image translation may be achieved by establishing a relationship between the two models so that sampling of the original image may be referred to during the conditional sampling. F* may be expressed as p(y|wᵢₙ).

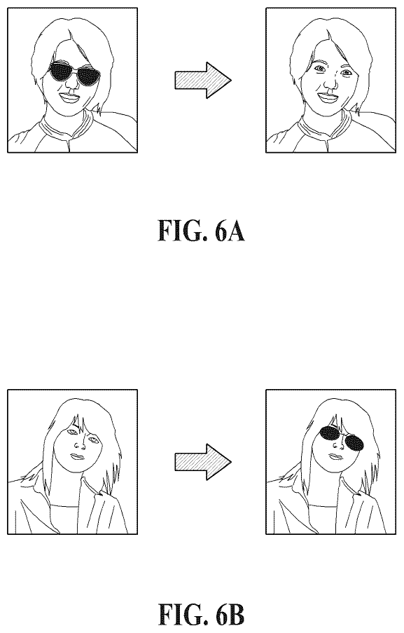

FIGS. 6A and 6B illustrate examples of image-to-image translation.

FIG. 6A shows an example of removing an object from image data, and FIG. 6B shows and example of adding an object to image data. In the non-limiting examples, the object corresponds to sunglasses.

In the examples, the left images correspond to an original image, and the right images correspond to a translated image.

Through diffusion-based image-to-image translation, an image with sunglasses removed or added compared to the original image may be obtained, and a translated image that follows the original image may be obtained, the translated image in which no other translations than the presence or absence of the sunglasses are found.

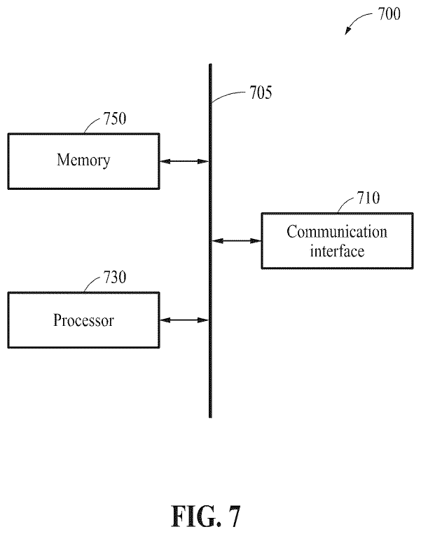

FIG. 7 illustrates a block diagram of an example of an apparatus.

Referring to FIG. 3, an apparatus 700 may include a communication interface 710, a processor 730 (e.g., one or more processors), and a memory 750 (e.g., one or more memories). The communication interface 710, the processor 730, and the memory 750 may communicate with one another via a communication bus 705.

The communication interface 710 may receive data including noise or may receive image data.

The processor 730 may sample data received through the communication interface 710. The processor 730 may perform image-to-image translation or conditional sampling through a plurality of iterations based on at least one diffusion model and at least one condition model.

The memory 750 may store various pieces of information generated in the processes described above performed by the processor 730. In addition, the memory 750 may store various types of data and programs. The memory 750 may include a volatile memory or a non-volatile memory. The memory 750 may include a large-capacity storage medium such as a hard disk to store a variety of data.

In addition, the processor 730 may perform at least one of the methods described with reference to FIGS. 1 to 6 or an algorithm corresponding to at least one of the methods. The processor 730 may be a hardware-implemented data processing device having a circuit that is physically structured to execute desired operations. The desired operations may include, for example, instructions or code included in a program. The processor 730 may be implemented as, for example, a central processing unit (CPU), a graphics processing unit (GPU), or a neural processing unit (NPU). For example, a hardware-implemented prediction apparatus 500 may include, for example, a microprocessor, a CPU, a processor core, a multi-core processor, a multiprocessor, an application-specific integrated circuit (ASIC), and a field programmable gate array (FPGA).

The processor 730 may execute a program and control the apparatus 700. Program code to be executed by the processor 730 may be stored in the memory 750. For example, the memory 750 may include a non-transitory computer-readable storage medium storing instructions that, when executed by the processor 730, configure the processor 730 to perform any one, any combination, or all of the operations and/or the methods disclosed herein with reference to FIGS. 1-6 and 8-9.

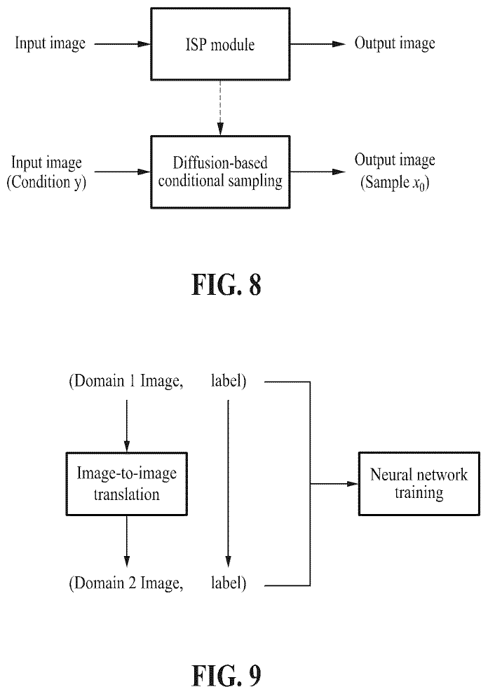

FIG. 8 illustrates an example of applying conditional sampling to an image signal process (ISP) module.

A module that performs a task for processing an image, for example, an ISP module for a task such as color demosaicking and deblurring, may be implemented with a conditional sampling process based on a diffusion model.

When a proximal operator of an ADMM module is configured by inputting an input image of the ISP module as a condition y and modeling a relationship between the input image and an output image for the performance by the ISP module as a likelihood model, a sample x₀ obtained through the conditional sampling process may correspond to a final output image.

Even when a plurality of ISP modules exist, a conditional sampling model may only use one module. By changing only a proximal operator corresponding to a role of each ISP module, the conditional sampling model may perform different roles for each proximal operator.

When a relationship between an initial input image and the final output image is modeled as a likelihood model by combining the plurality of ISP modules to implement the proximal operator of the ADMM, conditional sampling may be executed at once, through one conditional sampling process.

FIG. 9 illustrates an example of an operation for data augmentation.

When learning a neural network, a pair of an image and a label may be needed. However, the image may be an image obtained from a specific domain (referred to as Domain 1) and may have obtained a label thereof.

When training a neural network with the image and label of Domain 1, the neural network may operate correctly in the corresponding domain but may operate incorrectly in another domain (e.g., Domain 2).

To prevent this, an image and a label of Domain 2 may be obtained to be used in training, but obtaining the image of Domain 2 may not be easy and an additional labeling process may need to be performed.

When a label is maintained while the image of Domain 1 is automatically translated to the image of Domain 2 through an image-to-image translation process described with reference to FIGS. 4 to 6, the neural network may be trained through a data augmentation process.

The apparatuses, communication interfaces, processors, memories, communication buses, apparatus 700, communication interface 710, processor 730, memory 750, and communication bus 705 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described abo.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
obtaining input data that corresponds to noise;
iteratively updating the input data based on a diffusion model and a condition model; and
outputting image data that meets a sampling condition based on the iteratively updated data.

2. The method of claim 1, wherein the iterative updating of the input data comprises:
obtaining first data corresponding to the diffusion model and second data corresponding to the condition model, wherein the first data and the second data are output in a previous iteration; and
updating the obtained first data and the obtained second data in parallel based on the diffusion model and the condition model.

3. The method of claim 2, further comprising:
updating a linear coefficient to indicate a relationship between the first data and the second data,
wherein the updated linear coefficient is used in determining the first data and the second data in a next iteration.

4. The method of claim 2, wherein the obtaining of the first data corresponding to the diffusion model and the second data corresponding to the condition model comprises determining the second data based on the first data.

5. The method of claim 1, wherein the iterative updating of the input data comprises iteratively updating the input data based on an alternating direction method of multipliers (ADMM) that processes the diffusion model and the condition model in parallel.

6. The method of claim 1, wherein the condition model comprises a function for a task of the output image data.

7. The method of claim 1, wherein the iterative updating of the input data comprises reducing a step of updating the input data to 0 in a level unit of “1” or higher.

8. The method of claim 1, further comprising:
performing a second update, which iteratively updates the image data based on the diffusion model; and
outputting translated data that meets a translation condition by iterating a first update based on a result of the second update, the first update being the iterative updating of the input data.

9. A processor-implemented method comprising:
obtaining image data;
performing a first update, which iteratively updates the image data based on a diffusion model and a condition model;
performing a second update, which iteratively updates the image data based on the diffusion model; and
outputting translated data that meets a translation condition by iterating the first update based on a result of the second update.

10. The method of claim 9, wherein the condition model comprises a function that indicates a translation condition according to a semantic feature of the image data.

11. The method of claim 9, wherein the performing of the first update comprises:
obtaining first data corresponding to the diffusion model and second data corresponding to the condition model comprising a result of the second update, wherein the first data and the second data are output in a previous iteration; and
updating the obtained first data and the obtained second data in parallel.

12. The method of claim 11, wherein the obtaining of the first data corresponding to the diffusion model and the second data corresponding to the condition model comprising the result of the second update comprises determining the second data based on the first data.

13. The method of claim 11, wherein the performing of the first update comprises iteratively updating the image data based on an alternating direction method of multipliers (ADMM) that processes the diffusion model and the condition model in parallel.

14. A non-transitory computer-readable storage medium storing instructions that, when executed by one or more processors, configure the one or more processors to perform the operating method of claim 9.

15. An apparatus comprising:
one or more processors configured to:
obtain input data that corresponds to noise;
iteratively update the input data based on a diffusion model and a condition; and
output image data that meets a sampling condition based on the iteratively updated data.

16. The apparatus of claim 15, wherein, for the iterative updating of the input data, the one or more processors are configured to:
obtain first data corresponding to the diffusion model and second data corresponding to the condition model, wherein the first data and the second data are output in a previous iteration; and
update the obtained first data and the obtained second data in parallel based on the diffusion model and the condition model.

17. The apparatus of claim 16, wherein the one or more processors are configured to:
update a linear coefficient to indicate a relationship between the first data and the second data,
wherein the updated linear coefficient is used in determining the first data and the second data in a next iteration.

18. The apparatus of claim 16, wherein, for the obtaining of the first data corresponding to the diffusion model and the second data corresponding to the condition model, the one or more processors are configured to determine the second data based on the first data.

19. The apparatus of claim 15, wherein, for the iterative updating of the input data, the one or more processors are configured to iteratively update the input data based on an alternating direction method of multipliers (ADMM) that processes the diffusion model and the condition model in parallel.

20. An apparatus comprising:
one or more processors configured to:
obtain image data;
perform a first update, which iteratively updates the image data based on a diffusion model and a condition model;
perform a second update, which iteratively updates the image data based on the diffusion model; and
output translated data that meets a translation condition by iterating the first update based on a result of the second update.
